(19) United States
(12) Patent Application Publication
(10) Pub. No.: US 2026/0204739 A1
(43) Pub. Date: Jul. 16, 2026

(54) METHODS AND DEVICES FOR MAKING ELECTRICAL CONNECTIONS BETWEEN BATTERY CELLS AND BUSBARS IN AN ELECTRIC VEHICLE'S BATTERY PACK

(71) Applicant: FORD GLOBAL TECHNOLOGIES, LLC, Dearborn, MI (US)

(72) Inventors: Yongcai Wang, Ann Arbor, MI (US); Chi Paik, Grosse Ile, MI (US); Brian Utley, Canton, MI (US); Chung-hsing Kuo, Ann Arbor, MI (US); Jerry Lan, Ann Arbor, MI (US); Paul John Bojanowski, Macomb Township, MI (US); Frank Kim, South Lyon, MI (US); Kwon Shon, Troy, MI (US)

(21) Appl. No.: 19/017,013

(22) Filed: Jan. 10, 2025

(51) Int. Cl. H01M 50/507; H01M 50/249; H01M 50/516; H01M 50/552

(52) U.S. Cl. CPC H01M 50/507; H01M 50/249; H01M 50/516; H01M 50/552

(57) ABSTRACT

Battery tabs can be disposed through slots of a busbar and then deformed over a portion of the busbar. The battery tabs can be affixed to the busbar after they are deformed. The resulting busbar assembly can include a recess shaped to complement a body suitable for deforming the battery tabs.

### TECHNICAL FIELD

The present technology relates generally to electric vehicle battery packs. Particular embodiments of the present technology relate to methods and devices for making an electrical connection between battery cells and a busbar in an electric vehicle’s battery pack.

### BACKGROUND

Busbars, in part, conduct electrical energy and can serve as a center point of electrical energy distribution within the vehicle’s electrical system. Battery tabs can serve as the electrical conduit by which electrical energy stored in a battery cell is conducted to a busbar. The shape and configuration of a busbar, as well as its connection points for battery tabs, may be engineered to balance electrical conductivity, thermal management, mechanical stability, and assembly of the battery pack.

### SUMMARY

A method for manufacturing a vehicle battery pack involves rolling a cylinder in a first direction across a pair of aligned tabs that extend outward from one or more battery cells and pass through slots in a busbar. The busbar includes a separating portion positioned between the slots and adjacent to the aligned tabs. As the cylinder rolls in the first direction, the first tab plastically deforms over the first edge of the separating portion, while the second tab bends away from the separating portion without contacting the busbar. The method then continues by rolling the cylinder in the opposite direction, causing the second tab to plastically deform over the second edge of the separating portion.

A battery pack manufacturing station includes a pair of aligned tabs that extend outward from one or more battery cells and pass through slots in a busbar. The busbar features a separating portion positioned between the slots and adjacent to the aligned tabs. In this configuration, the first tab is plastically deformed over the first edge of the separating portion, while the second tab bends away from the separating portion without contacting the busbar. Additionally, the station includes a roller positioned adjacent to the second tab, with the second tab located between the first tab and the roller.

A method for manufacturing a vehicle battery pack involves sweeping a wiper in a first direction across a pair of aligned tabs that extend outward from one or more battery cells and pass through slots in a busbar. The busbar includes a separating portion positioned between the slots and adjacent to the aligned tabs. As the wiper moves in the first direction, the first tab plastically deforms over the first edge of the separating portion, while the second tab bends away from the separating portion without contacting the busbar.

### BRIEF DESCRIPTION OF THE DRAWINGS

FIG. 1A is a perspective view of a portion of a vehicle battery pack assembly.

FIG. 1B is a top view of a portion of a vehicle battery pack assembly.

FIG. 2 is a flow chart of a method of manufacture for a vehicle battery pack.

FIG. 3A is a top view of a portion of a vehicle battery pack assembly.

FIG. 3B is a side view of a portion of a vehicle battery pack assembly.

FIG. 4 is a perspective view of a portion of a busbar assembly.

### DETAILED DESCRIPTION

Embodiments of the present disclosure are described herein. The disclosed embodiments, however, are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention.

Various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

As used herein, singular terms should be understood to include their plural forms, and vice versa. Descriptive terms used herein, such as ‘about,’ ‘substantially,’ and ‘approximately,’ indicate possible variations within acceptable limits, as understood by one of ordinary skill in the art.

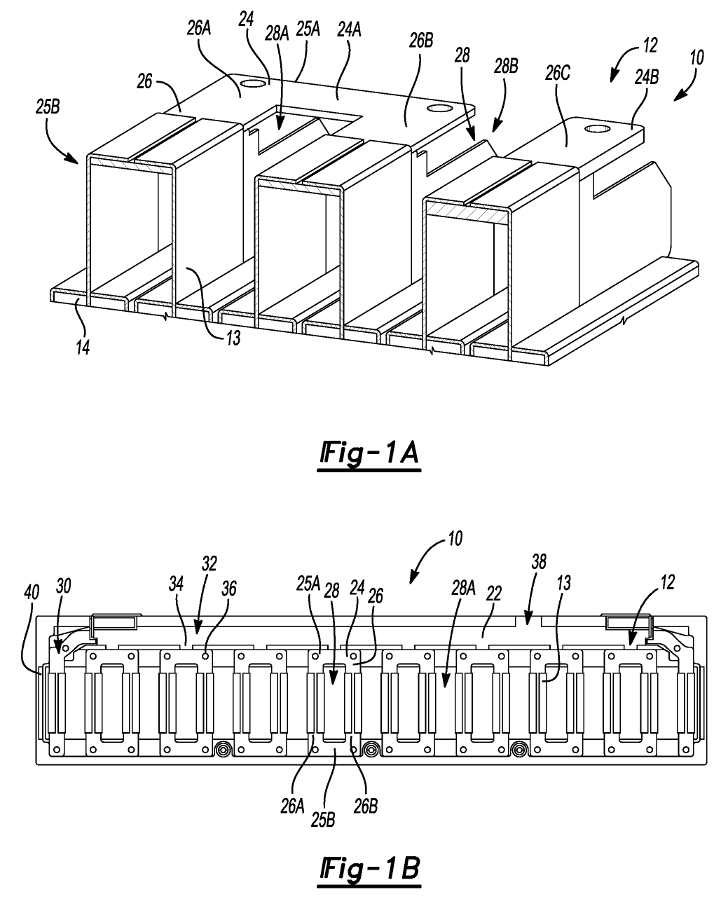

Without being bound by theory, embodiments of the present technology address busbar design and manufacturing efficiency. For example, making an electrical connection between a battery tab and a busbar can include folding or bending, or other deforming process, of the battery tab such that the battery tab can be closer in alignment with a surface of the busbar. FIG. 1A depicts a portion of a battery pack assembly 10. Battery pack assembly 10 can include a busbar assembly 12, a battery cell 14, and a battery tab 13. Busbar assembly 12 can include a frame (not depicted), a busbar 24, a busbar portion 26, and a battery tab slot 28. A busbar 24 or busbar portion 26 can have a surface suitable for electrically connecting a battery tab 13 thereon. For example, busbar 24 or busbar portion 26 can have a substantially flat surface with a first edge and second edge defining the substantially flat surface.

Busbar portion 26 is an integral section of busbar 24 and is configured to electrically and physically bridge between sides of busbar 24 such that busbar portion 26 extends over a battery cell 14. Busbar 24 may have more than one busbar portion 26. For example, busbar 24A has a first busbar portion 26A and a second busbar portion 26B spaced apart from busbar portion 26A. A busbar 24 may only have one busbar portion 26. For example, busbar 24B has only busbar portion 26C. Busbar assembly 12 may include more than one busbar 24. For example, busbar assembly 12 has busbar 24A and busbar 24B. The technology disclosed here considers other configurations of busbar 24 and busbar portion 26 beyond that depicted in FIG. 1A.

Battery tab slot 28 can be a gap in a single busbar 24, defined by two adjacent busbar portions 26 of a single busbar 24. For example, battery tab slot 28A is defined by the gap between busbar portion 26A and busbar portion 26B, wherein busbar portion 26A and busbar portion 26B are portions of busbar 24A. Battery tab slot 28 can also be a gap between more than one busbar 24. For example, battery tab slot 28B is defined by the gap between busbar 24A and busbar 24B.

A battery tab 13 is a current collector and may be in electrical connection with a battery cell 14. Battery tab 13 may be affixed to busbar portion 26 or busbar 24 such that battery tab 13 is in electrical connection with busbar portion 26 or busbar 24. In some embodiments, battery tab 13 is affixed to busbar portion 26 or busbar 24 with a weld, such as a laser weld. In some embodiments, battery tab 13 can be in electrical connection to a portion of a battery cell, multiple battery cells, or multiple portions of multiple battery cells, as the case may be. A battery tab 13 can have multiple layers of a current collector, such as stacked current collectors or layered current collectors, suitable for making electrical connections with a battery cell 14. In some embodiments, the multiple layers of battery tab 13 can be in electrical connection to a portion of a battery cell, multiple battery cells, or multiple portions of multiple battery cells, as the case may be. In some embodiments, battery tab 13 contains copper or aluminum, or other suitable material to conduct electricity. In some embodiments, battery tab 13 extends away from battery cell 14. In other embodiments, battery tab 13 extends away from a portion of a battery cell, multiple battery cells, or multiple portions of multiple battery cells, as the case may be. In operation, battery tab 13 facilitates electrical energy transfer from battery cell 14 to busbar portion 26 or busbar 24. In some embodiments, in operation, battery tab 13 facilitates the conduction of electrical energy from a portion of a battery cell, multiple battery cells, or multiple portions of multiple battery cells, as the case may be, to busbar portion 26 or busbar 24.

FIG. 1B depicts a portion of a battery pack assembly 10. For illustrative purposes, the battery source or battery sources are not shown in FIG. 1B. A battery pack assembly 10 can include a busbar assembly 12 and battery tabs 13. Busbar assembly 12 can include a frame 22, a busbar 24, a busbar portion 26, and a battery tab slot 28. Battery tab slot 28 can be the gap between busbar portions of the same busbar. For example, battery tab slot 28 is the gap between busbar portion 26A and 26B, wherein busbar portions 26A and 26B are portions of the same busbar 28. Busbar assembly 12 can also include battery tab slot 28A. Battery tab slot 28A can be the gap between two separate busbars. Furthermore, busbar portion 26 electrically and contiguously bridges between a first side 25A of busbar 24 to a second side 25B of busbar 24.

The busbar assembly 12 can also include an integrated end busbar terminal 30, a flexible printed circuit (FPC) trench 32, a FPC 34, heat stake 36, a FPC outlet channel 38, and a recess 40. In some embodiments, busbar assembly 12 can have one busbar 24. In other embodiments, busbar assembly 12 can have two, three, four, five, six, or more busbars 24. In some embodiments, busbar 24 has two busbar portions 26. For example, busbar 24 has busbar portion 26A and busbar portion 26B. In other embodiments, busbar 24 can have one, three, four, five, six, or more busbar portions 26.

Frame 22, in part, is a support bracket and supports portions of busbar 24, busbar portion 26, busbar terminal 30, and FPC 34, and defines FPC trench 32 and FPC outlet channel 38. Each busbar 24 can be in electrical connection with another busbar 24 via suitable means, such as with FPC 34. The FPC 34 may traverse along frame 22 in the FPC trench 32 and exit the busbar assembly 12 at FPC outlet channel 38. FPC 34 may also be in electrical connection with integrated end busbar terminal 30. During operation, electrical energy from busbar 24 or busbar portion 26 may be conducted through FPC 34. Busbar 24 may be disposed over a heat stake 36 such that the heat stake 36 extends through a hole in busbar 24. A purpose of the heat stake 36 may be to mount and align busbar 24 onto frame 22.

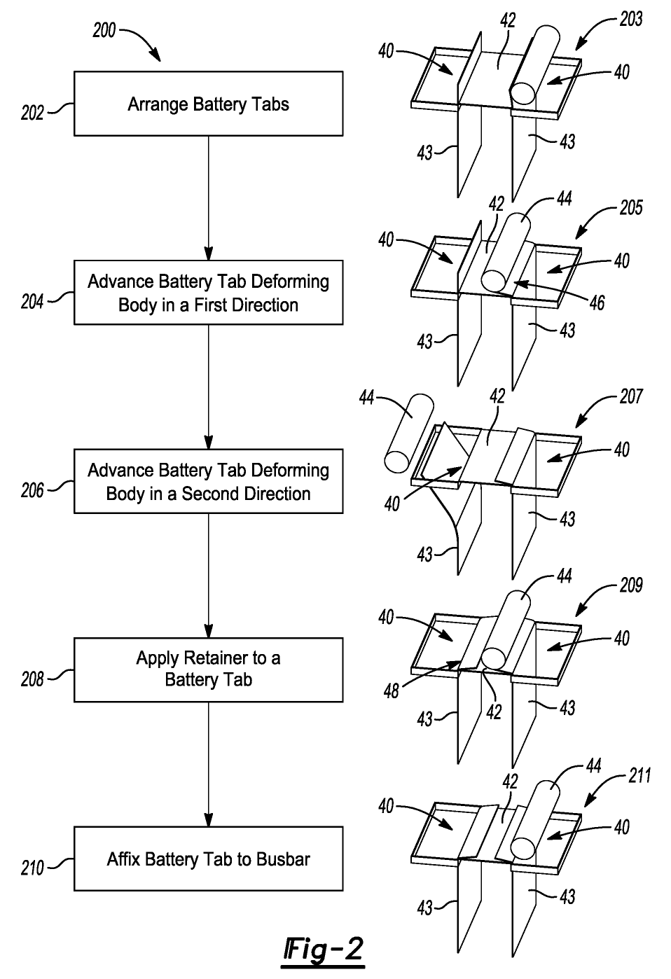

FIG. 2 is a diagram of a method 200 for manufacturing a vehicle battery pack. Method 200 can include step 202. At step 202, a pair of battery tabs are suitably arranged proximate to a busbar having a portion. Each of the pair of battery tabs extends away from a battery cell and through a busbar slot defined by the busbar portion, such that the battery busbar portion is adjacent to but separating the pair of battery tabs and such that the pair of battery tabs are aligned in a row. In other embodiments, the pair of battery tabs can further be arranged with a surface of each battery tab orientated to be parallel along a shared normal vector.

An example of this shown in illustration 203. A pair of battery tabs 43 are aligned and disposed through battery tab slots 40 such that a busbar portion 42 is adjacent to but separating the pair of aligned battery tabs 43. In some embodiments, battery tabs 43 correspond to, or are part of, battery tabs 13 as described with respect to FIG. 1A and FIG. 1B. In some embodiments, busbar portion 42 corresponds to, or is part of, busbar portion 26 as described with respect to FIG. 1A and FIG. 1B. In some embodiments, battery tab slots 40 correspond to, or are part of, battery tab slots 28 as described with respect to FIG. 1A and FIG. 1B.

At step 204, a deforming body is advanced in a first direction such that the deforming body deforms a first battery tab of a pair of aligned battery tabs against an edge of a busbar portion. In some embodiments, the first battery tab of the pair of aligned battery tabs contacts a surface of the busbar portion. In some embodiments, the first battery tab is plastically deformed. In other embodiments, the first battery tab is elastically deformed. The deforming body can be a roller, cylinder, wedge, angle, wiper, or other body suitable for engaging with a surface and deforming one of the pair of aligned battery tabs over an edge of a busbar portion. The deforming body can be advanced in the first direction by suitable means such as robotic arms, pneumatic, electrical, or mechanical actuators, conveyor systems, rack and pinion systems, pneumatic or hydraulic cylinder systems, or motorized carriages, among others.

After the deforming body engages the first of the aligned battery tabs in the first direction, the deforming body continues to advance in the first direction and engages a second battery tab of the pair of aligned battery tabs. The second battery tab of the pair of aligned battery tabs is elastically bent in the first direction, away from the busbar portion, but does not contact an edge or surface of an adjacent busbar portion. After the deforming body moves beyond the second battery tab of the pair of aligned battery tabs, the second battery tab returns to a position substantially similar to its position before the deforming body engages the second battery tab.

An example of this is shown in illustration 205 and 207. In illustration 205, deforming body 44 is a cylinder and rolls in a first direction (e.g., right to left). The first battery tab of the pair of aligned battery tabs 43 is plastically deformed over edge 46 of busbar portion 42 by deforming body 44 and contacts a surface of busbar portion 42. In some embodiments, battery tabs 43 correspond to, or are part of, battery tabs 13 as described with respect to FIG. 1A and FIG. 1B. In some embodiments, busbar portion 42 corresponds to, or is part of, busbar portion 26 as described with respect to FIG. 1A and FIG. 1B. In some embodiments, battery tab slots 40 correspond to, or are part of, battery tab slots 28 as described with respect to FIG. 1A and FIG. 1B.

In illustration 207, deforming body 44 is a cylinder and continues to roll in the first direction after deforming the first battery tab of the pair of aligned battery tabs 43. As deforming body 44 engages the second battery tab of the pair of aligned battery tabs 43, the second battery tab of the pair of aligned battery tabs 43 does not deform over an adjacent edge of a busbar portion 42. Instead, the second battery tab of the pair of aligned battery tabs 43 elastically bends in the first direction, away from busbar portion 42. After the deforming body passes beyond the a distal end of the second battery tab of the pair of aligned battery tabs 43, the second battery tab returns to a position substantially similar to its position before deforming body 44 engages the second battery tab. In some embodiments, battery tabs 43 correspond to, or are part of, battery tabs 13 as described with respect to FIG. 1A and FIG. 1B. In some embodiments, busbar portion 42 corresponds to, or is part of, busbar portion 26 as described with respect to FIG. 1A and FIG. 1B. In some embodiments, battery tab slots 40 correspond to, or are part of, battery tab slots 28 as described with respect to FIG. 1A and FIG. 1B.

At step 206, the deforming body is advanced in a second direction. In some embodiments, the second direction is opposite the first direction. As the deforming body advances in the second direction, the second battery tab of the pair of aligned battery tabs is engaged by the deforming body and is deformed over a second edge of the busbar portion. In some embodiments, the second battery tab of the pair of aligned battery tabs contacts a surface of the busbar portion. In some embodiments, a second battery tab is plastically deformed. In other embodiments, the second battery tab is elastically deformed. After the deforming body engages the second battery tab of the aligned pair of battery tabs in the second direction, the deforming body continues to advance in the second direction but does not engage with the first battery tab of the pair of aligned battery tabs as the first battery tab of the pair of aligned battery tabs has been previously deformed at step 204 such that the first battery tab of the pair of aligned battery tabs substantially passes underneath the path of the deforming body.

An example of this is shown in illustration 209 and 211. In illustration 209, deforming body 44 is a cylinder and rolls in a second direction (e.g., left to right). The second battery tab of the pair of aligned battery tabs 43 is plastically deformed over edge 48 of busbar portion 42 and contacts the surface of busbar portion 42. In some embodiments, battery tabs 43 correspond to, or are part of, battery tabs 13 as described with respect to FIG. 1A and FIG. 1B. In some embodiments, busbar portion 42 corresponds to, or is part of, busbar portion 26 as described with respect to FIG. 1A and FIG. 1B. In some embodiments, battery tab slots 40 correspond to, or are part of, battery tab slots 28 as described with respect to FIG. 1A and FIG. 1B.

In illustration 211, as the deforming body 44 continues in the second direction after deforming the second battery tab of the pair of aligned battery tabs 43, the deforming body passes over the first battery tab of the pair of aligned battery tabs such that the first battery tab of the pair of aligned battery tabs 43 passes below the surface of deforming body 44. In some embodiments, battery tabs 43 correspond to, or are part of, battery tabs as described with respect to FIG. 1A and FIG. 1B. In some embodiments, busbar portion 42 corresponds to, or is part of, busbar portion 26 as described with respect to FIG. 1A and FIG. 1B. In some embodiments, battery tab slots 40 correspond to, or are part of, battery tab slots 28 as described with respect to FIG. 1A and FIG. 1B.

In some embodiments, a deforming body to busbar portion gap distance, representative of the distance between the surface of the deforming body and a busbar portion, is adjusted by setting a path of the deforming relative to a surface of the busbar portion. In some embodiments, the deforming body to busbar portion gap distance is substantially reduced, thereby reducing an airgap between one of the pair of aligned battery tabs and busbar portion after one of the pair of aligned battery tabs has been deformed by the deforming body. This can be advantageous for at least the reason that the airgap between the pair of aligned battery tabs and busbar portion is set only once during manufacturing.

At step 208, a battery tab retainer can be applied to a battery tab such that the battery tab is temporarily held in place and contacts a surface of a busbar portion. The battery tab retainer can be a rigid bar, flexible bar, stamp, or of other suitable shape to substantially hold the battery tab against the surface of the busbar portion. The battery tab retainer can be applied to the battery tab by suitable means such as robotic arms, pneumatic or mechanical actuators, conveyor systems, rack and pinion systems, pneumatic or hydraulic cylinder systems, or motorized carriages, among others.

At step 210, a battery tab is affixed to a surface of a busbar portion such that an electrical connection is established between the battery tab and the busbar portion and such that the battery tab retainer can be removed while the battery tab remains in electrical communication with the busbar portion. In some embodiments, laser welding is used to affix the battery tab to the surface of the busbar portion, but other methods can include ultrasonic welding, resistance welding, soldering, adhesives, or mechanical fastening, such as bolts, rivets, or clips.

Method 200 may offer several advantages. For instance, method 200 allows for wider battery tab slots, which can make positioning a battery tab relative to a busbar portion easier. Additionally, wider slots can enable the use of smaller busbars, reducing the overall mass of the busbar assembly. Method 200 can also increase the speed of positioning battery tabs in relation to a busbar. Furthermore, using a cylinder as the deforming body in method 200 reduces the tension force exerted on a battery cell by a connected battery tab during the battery tab deformation process, preserving the integrity of the battery tab’s electrical connection with the battery cell.

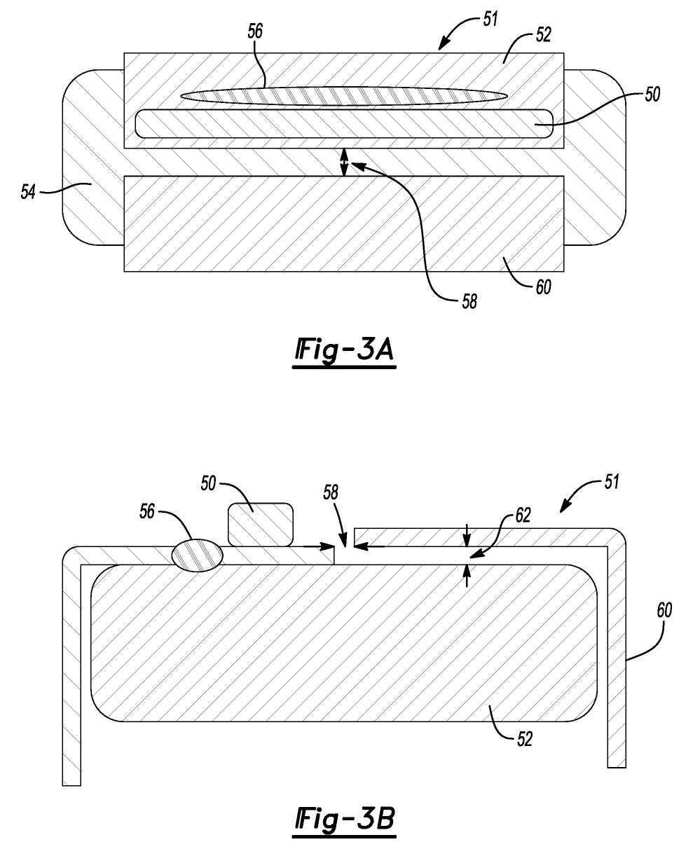

FIG. 3A and 3B depict a portion of manufacturing a battery pack assembly 51. For illustrative purposes, the battery source or battery sources are not shown in FIG. 3A and 3B. In some embodiments, FIG. 3A and 3B correspond to step 208 and 210 of the method of manufacture 200. In FIG. 3A, a battery tab retainer 50 presses a first battery tab 52 against a surface of busbar portion 54 such that battery tab 52 can be affixed to the surface of busbar portion 54. In some embodiments, laser weld 56 affixes the first battery tab 52 to the surface of busbar portion 54. It should be understood that other methods of affixing the battery tab 52 to busbar portion 54 are contemplated by the present technology.

In some embodiments, there exists a gap distance 58 representative of the distance between a first battery tab 52 and a second battery tab 60 when the first battery tab 52 and second battery tab 60 are affixed to the surface of busbar portion 54. Gap distance 58 can reduce unintended conductive paths between the first battery tab 52 and the second battery tab 60. In some embodiments, gap distance 58 is 1mm, 2mm, 3mm, 4mm, 5mm, or larger. Further, gap distance 58 can allow for thermal expansion of the first battery tab 52, the second battery tab 60, and busbar portion 54, affecting the overall mechanical stability of a vehicle battery pack. Additionally, gap distance 58 between the first battery tab 52 and the second battery tab 60 can increase heat dissipation of a busbar assembly, such as by facilitating airflow.

As shown in FIG. 3B, laser weld 56 extends through the first battery tab 52 and partially into the surface of the busbar portion 56, affixing the first battery tab 52 to the busbar portion. Laser weld 56, or an alternative attachment method, can be applied to the first battery tab 52 using suitable equipment, such as robotic systems. In some embodiments, battery tab 52 can have multiple layers of current collectors. As such, the battery tab retainer 50 is suited to provide sufficient clamping force to eliminate gaps between the multiple layers such that a sufficient electrical connection is made between the multiple layers of battery tab 52, laser weld 56, and busbar portion 56.

In some embodiments, an air gap exists between battery tab 60 and busbar portion 56 before the battery tab is pressed into position by a battery tab retainer. For instance, an air gap 62 is present between the second battery tab 60 and the surface of busbar portion 52. Airgap 62 can be reduced by setting a path of a deforming body to be closer to the surface of busbar portion 56, such as in steps 204 and 206 of method 200. When a battery tab retainer, such as retainer 50, presses the second battery tab 60 against the busbar portion 52, air gap 60 is substantially reduced, allowing the battery tab 60 to be affixed to the busbar surface by a laser weld, or other suitable affixing method.

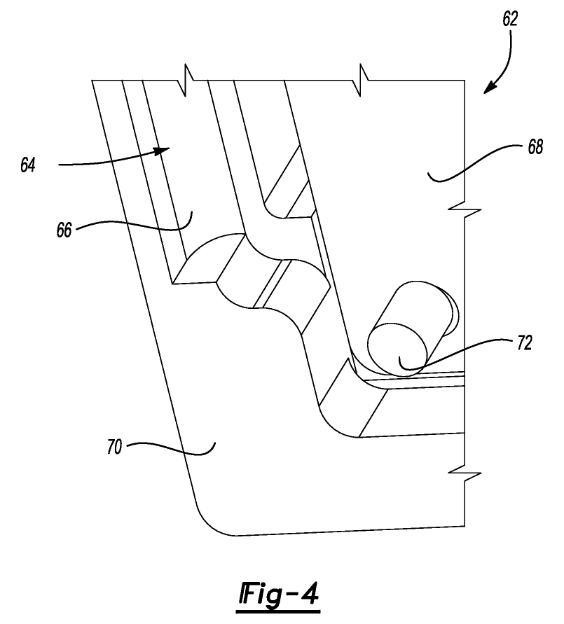

FIG. 4 is a portion of a busbar assembly 62, according to embodiments of the present technology. In some embodiments, busbar assembly 62 corresponds to, or is part of, busbar assembly 12 as described with respect to FIG. 1A and 1B. Busbar assembly 62 can have recess 64, frame 70, busbar 68, and heat stake 72. Heat stake 72 can extend through busbar 68 and space busbar 68 away from frame 70. In some embodiments, heat stake 72 orients busbar 68 in a suitable position on frame 70, such as extending busbar 68 between sides of frame 70. In some embodiments, busbar assembly 62 can have an opposing recess 64 on an opposite side of busbar assembly 62.

In some embodiments, recess 64 corresponds to, or is part of, recess 40 as described with respect to FIG. 1B. Recess 64 is suitably shaped to complement a shape of a deforming body, such as the deforming body described with respect to method 200. Recess 64 can have recess wall 66, and recess wall 66 can complement an exterior surface of the deforming body. For example, in some embodiments, the deforming body in method 200 is a cylinder, and recess wall 66 has a radius substantially similar to a radius of the cylinder. Recess 64 can allow the deforming body to substantially engage an adjacent battery tab during steps 204 and 206 of method 200, while also reducing an overall length of busbar assembly 62.

What is claimed is:

1. A method for manufacturing a vehicle battery pack, comprising:
rolling in a first direction a cylinder across a pair of aligned tabs that extend away from one or more battery cells and through slots of a busbar having a portion that separates the slots and is adjacent to and between the pair of aligned tabs such that a first tab of the aligned tabs plastically deforms over a first edge of the portion and a second tab of the aligned tabs bends away from the portion without contacting the busbar; and
rolling in a second direction opposite the first direction the cylinder across the pair of aligned tabs such that the second tab of the aligned tabs plastically deforms over a second edge of the portion.

2. The method of claim 1, wherein the first tab plastically deforms over the first edge and contacts a face of the portion.

3. The method of claim 1, wherein the second tab plastically deforms over the second edge and contacts a face of the portion.

4. The method of claim 1 further comprising affixing the pair of aligned tabs to the bridge such that the aligned tabs are in electrical connection with the busbar.

5. The method of claim 4, wherein the aligned tabs are affixed to the portion with a weld.

6. The method of claim 4, wherein the aligned tabs are affixed on the portion such that there is a gap on a surface of the portion between the aligned tabs.

7. The method of claim 1, wherein each of the aligned tabs further comprises multiple layers of a current collector.

8. A battery pack manufacturing station comprising:
a pair of aligned tabs extending away from one or more battery cells and through slots of a busbar having a portion that separates the slots and is adjacent to and between the pair of aligned tabs such that a first tab of the aligned tabs is plastically deformed over a first edge of the portion and a second tab of the aligned tabs is bent away from the portion without contacting the busbar; and
a roller adjacent to the second tab such that the second tab is between the first tab and the roller.

9. The battery pack manufacturing station of claim 8, wherein a surface of the first tab is in contact with a surface of the portion.

10. A method for manufacturing a vehicle battery pack, comprising:
sweeping in a first direction a wiper across a pair of aligned tabs that extend away from one or more battery cells and through slots of a busbar having a portion that separates the slots and is adjacent to and between the pair of aligned tabs such that a first tab of the aligned tabs plastically deforms over a first edge of the portion and a second tab of the aligned tabs bends away from the portion without contacting the busbar.

11. The method of claim 10 further comprising sweeping in a second direction opposite the first direction the wiper across the pair of aligned tabs such that the second tab of the aligned tabs plastically deforms over a second edge of the portion.

12. The method of claim 10, wherein the first tab of the aligned tabs plastically deforms over the first edge of the portion and contacts the portion.

13. The method of claim 12, wherein the second tab of the aligned tabs plastically deforms over the second edge of the portion and contacts the portion.

14. The method of claim 10 further comprising affixing the pair of aligned tabs to the portion such that the aligned tabs are in electrical connection with the busbar portion.
